(19) United States
(12) Patent Application Publication
(10) Pub. No.: US 2019/0353427 A1
(43) Pub. Date: Nov. 21, 2019

(54) DOUBLE-TUBE INTERNAL HEAT EXCHANGER

(71) Applicant: DENSO International America, Inc., Southfield, MI (US)

(72) Inventor: Matthew JOHNSON, Royal Oak, MI (US)

(21) Appl. No.: 15/983,207

(22) Filed: May 18, 2018

(51) Int. Cl. F28D 7/10; F28F 13/12

(52) U.S. Cl. CPC F28D 7/106; B60H 2001/3291; F28F 13/12

(57) ABSTRACT

A double-tube internal heat exchanger has an outer tube, an inner tube, and a turbulator. The inner tube is inserted into the outer tube and defines an inner flow channel therein through which a first fluid flows. The inner tube and the outer tube define an outer flow channel therebetween through which a second fluid flows. The turbulator is disposed inside the inner flow channel. The inner tube includes an inner surface defining an inner groove that helically extends on the inner tube along an axial direction of the inner tube. The turbulator includes a flexible core portion extending along the axial direction and loops protruding from the flexible core portion in a radial direction of the inner tube. Each of the inner tube and the outer tube includes a bent portion that is formed by bending both the inner tube and the outer tube together with the turbulator.

### TECHNICAL FIELD

The present disclosure relates to a double-tube internal heat exchanger.

### BACKGROUND

Double-tube internal heat exchangers conventionally have an outer tube and an inner tube located inside the outer tube. The inner tube defines an inner flow channel therein. The outer tube and the inner tube define an outer flow channel therebetween. The double-tube internal heat exchanger exchanges heat between a first fluid, which flows through the inner flow channel, and a second fluid, which flows through the outer flow channel.

### SUMMARY

As an aspect of the present disclosure, a double-tube internal heat exchanger has an outer tube, an inner tube, and a turbulator. The inner tube is inserted into the outer tube and defines an inner flow channel therein through which a first fluid flows. The inner tube and the outer tube define an outer flow channel therebetween through which a second fluid flows. The turbulator is disposed inside the inner flow channel of the inner tube. The inner tube includes an inner surface defining an inner groove that helically extends on the inner tube along an axial direction of the inner tube. The turbulator includes a flexible core portion extending along the axial direction and loops protruding from the flexible core portion in a radial direction of the inner tube. Each of the inner tube and the outer tube includes a bent portion that is formed by bending both the inner tube and the outer tube together with the turbulator.

### BRIEF DESCRIPTION OF THE DRAWINGS

FIG. 1 is a diagram illustrating a schematic configuration of a vehicle air conditioner as one embodiment.

FIG. 2 is a diagram illustrating a double-tube internal heat exchanger according the embodiment.

FIG. 3 is a cross-sectional view of a portion III shown in FIG. 2.

FIG. 4 is a cross-sectional view taken along a line IV-IV shown in FIG. 3.

FIG. 5 is a cross-sectional view of a portion V shown in FIG. 2 and illustrating a part of a bent portion of the double-tube internal heat exchanger.

FIG. 6 is a cross-sectional view taken along a line VI-VI shown in FIG. 5.

FIG. 7 is an axial cross-sectional view illustrating an inner tube and a turbulator of the double-tube internal heat exchanger relating to the embodiment.

### DETAILED DESCRIPTION

### Embodiment

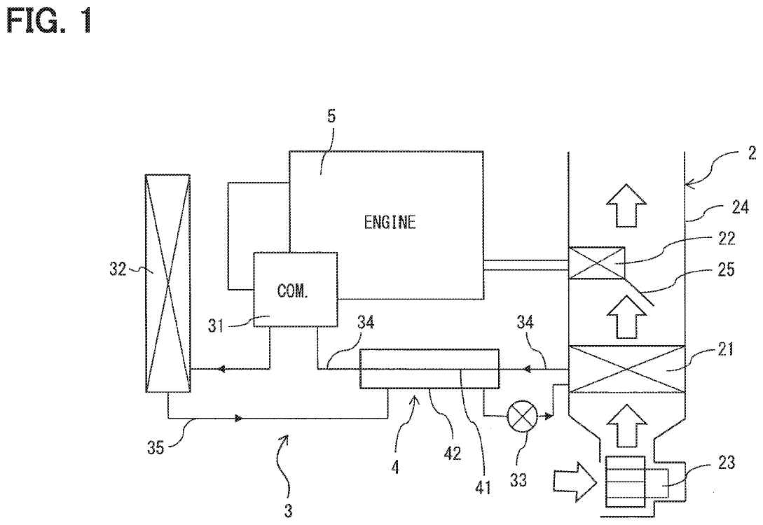

An embodiment will be described hereinafter referring to FIGS. 1 to 7.

In this embodiment, a double-tube internal heat exchanger 4 is mounted to a refrigeration cycle device 3 for a vehicle air conditioner 1.

The vehicle air conditioner 1 has an air conditioning unit 2 that adjusts a temperature of air and then supplies the air into a vehicle compartment. The air conditioning unit 2 includes an evaporator 21, a heater 22, a blower 23, a housing 24, and an air mix door 25. The housing 24 houses the evaporator 21, the heater 22, the blower 23, and the air mix door 25. The blower 23 is located in a most-upstream area inside the housing 24. The blower 23 draws air from an outside of the housing 24 and discharges the air toward the evaporator 21 and the heater 22. The evaporator 21 is located downstream of the blower 23 and upstream of the heater 22 in a flow direction of the air. The evaporator 21 cools the air to be a cool air. The heater 22 heats the cool air, which flows into the heater 22, to be a warm air.

The cool air and the warm air are mixed to be a conditioned air, which has a desired temperature, on a downstream side of the heater 22 in the housing 24. The conditioned air is supplied into a vehicle compartment of the vehicle. The air mix door 25 is located upstream of the heater 22 and positioned adjacent to the heater 22 in the housing 24. The air mix door 25 is configured to adjust a mixing ratio between the cool air and the warm air such that the conditioned air has the desired temperature.

The refrigeration cycle device 3 includes the evaporator 21, a compressor 31, a condenser 32, an expansion valve 33, and the double-tube internal heat exchanger 4. Pipes connect those components of the refrigeration cycle device 3 to form a closed circuit.

An internal combustion engine drives the compressor 31. The internal combustion engine will be referred to as the engine 5 hereinafter. The compressor 31 draws a low-pressure refrigerant in a gas state, compresses the low-pressure refrigerant to be a high-pressure and high-temperature refrigerant having a high pressure and a high temperature and being in a liquid state, and then discharges the high-pressure and high-temperature refrigerant. The high-pressure and high-temperature refrigerant exiting the compressor 31 flows into the condenser 32. The condenser 32 is a high-pressure side heat exchanger and serves as a radiator. The condenser 32 dissipates heat of the high-pressure and high-temperature refrigerant, and therefore the high-pressure and high-temperature refrigerant becomes a high-pressure refrigerant having a high pressure and being in a liquid state. The high-pressure refrigerant flows into the expansion valve 33 via the double-tube internal heat exchanger 4. A configuration of the double-tube internal heat exchanger 4 will be described later.

The expansion valve 33 is a pressure reducer. The expansion valve 33 expands and decompresses the high-pressure refrigerant flowing from the condenser 32, and therefore the high-pressure refrigerant becomes a gas-liquid two-phase refrigerant having a low pressure. The pressure reducer is not limited to be the expansion valve 33 and an ejector may replace the expansion valve 33 to serve as the pressure reducer. The gas-liquid two-phase refrigerant flows into the evaporator 21. The evaporator 21 is a low-pressure side heat exchanger and evaporates the gas-liquid two-phase refrigerant to be the low-pressure refrigerant in the gas state. The low-pressure refrigerant flows into the compressor 31. The evaporator 21 generates a latent heat when evaporating the gas-liquid two-phase refrigerant and cools the air using the latent heat in the air conditioning unit 2.

The configuration of the double-tube internal heat exchanger 4 will be described in detail hereinafter.

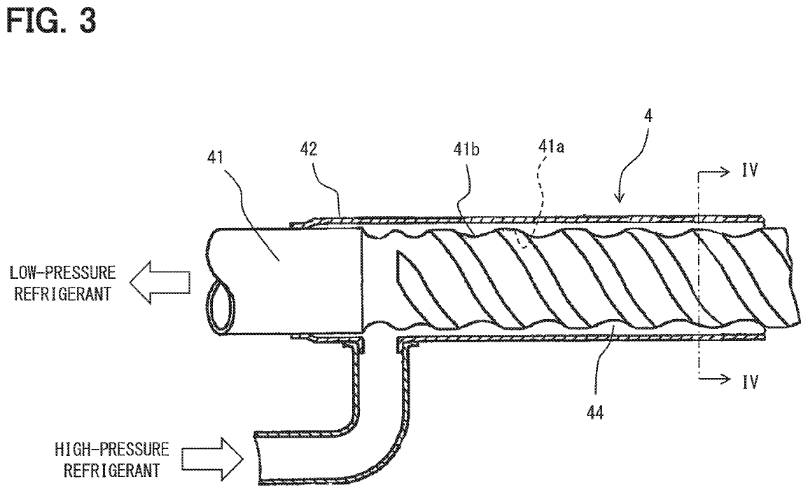

As shown in FIG. 3, the double-tube internal heat exchanger 4 includes an inner tube 41 and an outer tube 42. The inner tube 41 and the outer tube 42 are made of metal such as aluminum. The inner tube 41 is inserted into the outer tube 42. The inner tube 41 defines an inner flow channel 43 therein. The inner tube 41 and the outer tube 42 define an outer flow channel 44 therebetween.

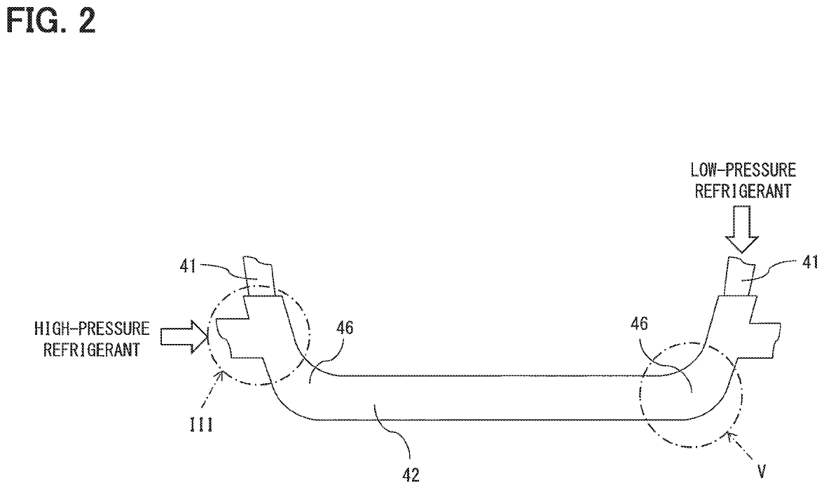

As shown in FIG. 1 and FIG. 2, the inner tube 41 includes an inlet, which is connected to an outlet of the evaporator 21, and an outlet, which is connected to an inlet of the compressor 31. Therefore, the low-pressure refrigerant (or a first fluid) exiting the evaporator 32 flows into the compressor 31 through the inner flow channel 43. The outer tube 42 includes an inlet, which is connected to an outlet of the condenser 32, and an outlet, which is connected to an inlet of the expansion valve 33. Therefore, the high-pressure refrigerant (or a second fluid) exiting the condenser 32 flows into the expansion valve 33 through the outer flow channel 44.

As shown in FIG. 1 and FIG. 3, the low-pressure refrigerant flows through the inner flow channel 43 in a direction which is opposite to a direction in which the high-pressure refrigerant flows through the outer flow channel 44. Thus, the double-tube internal heat exchanger 4 performs convective heat exchange between the low-pressure refrigerant and the high-pressure refrigerant.

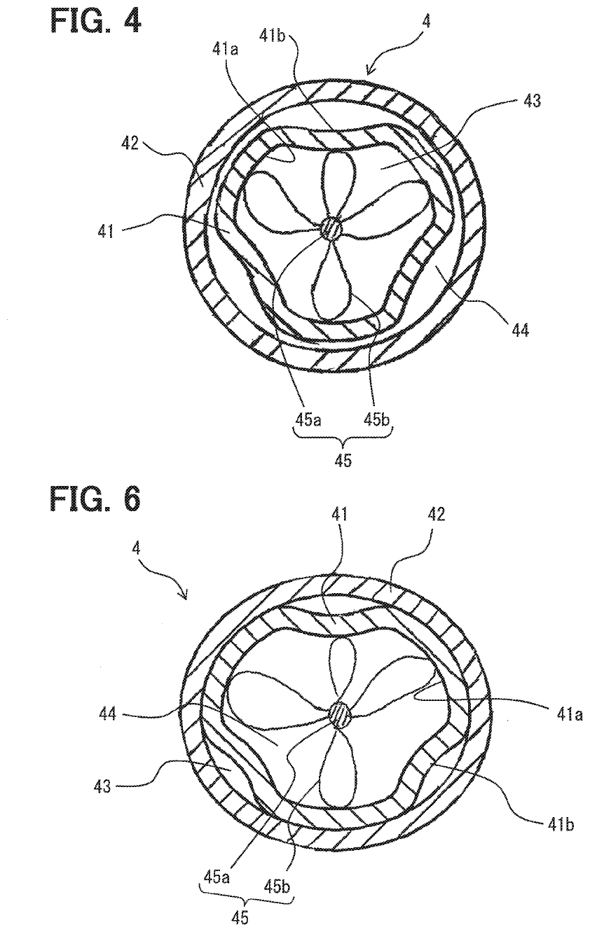

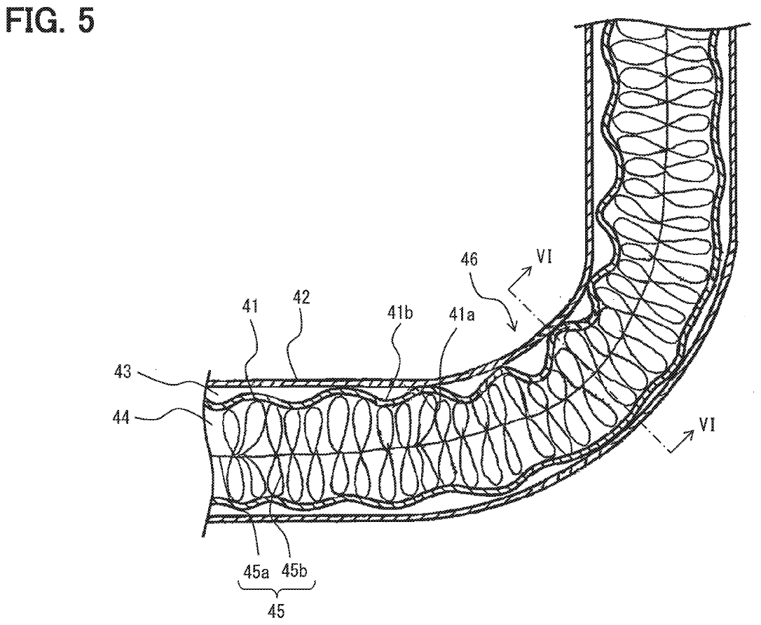

As shown in FIG. 3, the inner tube 41 includes a threaded portion. The threaded portion is formed, for example, by turning the inner tube 41 while being pressed with a die (not shown) to form an integrally rolled thread on an outer surface of the inner tube 41. Specifically, the die distorts the outer surface of the inner tube 41 to form an outer groove 41b extending helically on the outer surface of the inner tube 41 along an axial direction of the inner tube 41. As a result, an inner groove 41a is left (or defined) on an inner surface of the inner tube 41 as a non-pressed portion (see FIG. 4 and FIG. 5). When viewed from the inner side of the inner tube 41, the inner groove 41a is recessed outward from the inner surface in a radial direction of the inner tube 41 and extends on the inner surface along the axial direction of the inner tube 41. That is, the outer groove 41b and the inner groove 41a parallelly extend in a helical manner.

As shown in FIG. 3, the outer groove 41b and the inner groove 41a are offset from each other in the axial direction. As a result, the threaded portion has a cross-section, which is taken along the axial direction, having a plurality of peaks (as shown in FIG. 3) and a plurality of valleys (as shown in FIG. 3) that are arranged alternately with each other in the axial direction. In other words, the plurality of peaks constitute the inner groove 41a, and the plurality of the valleys constitute the outer groove 41b.

The inner tube 41 is inserted into the outer tube 42 so that the outer tube 42 covers entirely the threaded portion of the inner tube 41. The end portions of the outer tube 42 are pressed and welded against the inner tube 41 to gas-tightly prevent the high-pressure refrigerant from releasing through a space between the outer tube 42 and the inner tube 41. A diameter of the inner tube 41 is smaller than a diameter of the outer tube 42, and therefore a clearance is defined between the inner tube 41 and the outer tube 42 in the radial direction. The clearance serves as the outer flow channel 44 as described above.

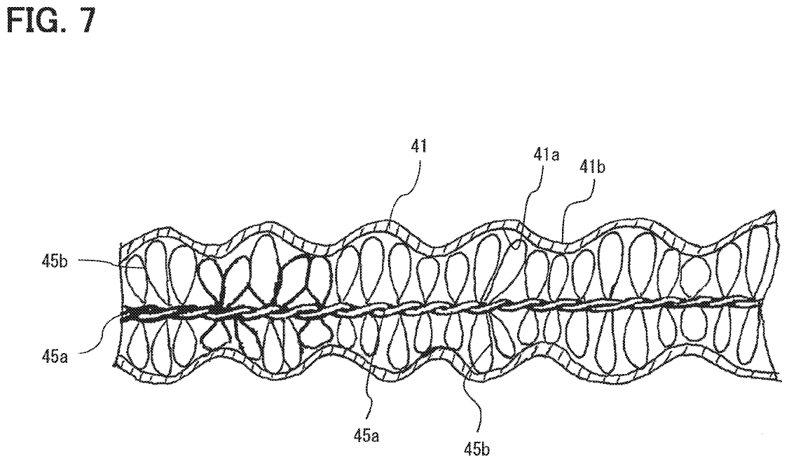

The double-tube internal heat exchanger 4 further includes the turbulator 45 that is inserted into the inner flow channel 43 of the inner tube 41. The turbulator 45 is made of material such as metal with certain heat conductivity. As shown in FIG. 7, the turbulator 45 includes a flexible core portion 45a extending along the axial direction and a plurality of loops 45b each protruding from the flexible core portion 45a in the radial direction. The low-pressure refrigerant passes through the loops 45b whereby the turbulator 45 generates a turbulent flow in the low-pressure refrigerant flowing through the inner flow channel 43.

For example, the loops 45b are arranged along the axial direction of the inner tube 41 at equal intervals across the turbulator 45. As shown in FIG. 4, the loops 45b are located inside the peaks of the inner groove 41a. In other words, each of the peaks has at least one loop 45b. The loops 45b are in contact with the inner surface of the inner tube 41a. In the present embodiment, the loops 45b are in contact with bottom portions of the peaks (i.e., the inner groove 41a).

As shown in FIG. 2, the double-tube internal heat exchanger 4 is bent such that two bent portions 46 (i.e., two curves) are formed. Each of the bent portions 46 is formed by bending both the inner tube 41 and the outer tube 42 together with the turbulator 45 at the same time. As shown in FIG. 5, in the bent portion 46, the peaks (the inner groove 41a) are in contact with the outer tube 42 so that the outer tube 42 holds the inner tube 41 tightly. As shown in FIG. 6, in the bent portion 46, the turbulator 45 is in contact with the inner surface of the inner tube 41 so that the inner tube 41 holds the turbulator 45.

Next, one example of a manufacturing method of the double-tube internal heat exchanger 4 will be described hereafter.

In the present embodiment, the double-tube internal heat exchanger is manufactured through the following steps.

First, a thread forming step is performed to form the threaded portion of the inner tube 41. For example, the threaded portion is formed using a die as described above. Then, in a first inserting step, the inner tube 41 is inserted into the outer tube 42. When the inner tube 41 is inserted into the outer tube 42, the outer flow channel 44 is formed between the inner tube 41 and the outer tube 42. Next, in a second inserting step, the tabulator 45 is inserted into the inner tube 41. When the turbulator 45 is inserted into the inner tube 41, the turbulator 45 is located inside the peaks of the inner groove 41a. In the present embodiment, the loops 45b are in contact with the bottom portions of the inner groove 41a defining the peaks of the inner groove 41a. It should be noted that the turbulator 45 is formed by twisting two wires together, and then winding another wire around the flexible core portion 45a such that the loops 45b spiral around the flexible core portion 45a. The another wire forming the loops 45b is twisted to the flexible core portion 45a such that the loops 45b are fixed to the flexible core portion 45a tightly. Also it should be understood that the order of performing the first inserting step and the second inserting step may be changed. That is, the first inserting step may be performed after the tabulator 45 is inserted into the inner tube 41 (i.e., the second inserting step).

In a bending step, the inner tube 41 and the outer tube 42 are bent together with the turbulator 45 to form two bent portions as shown in FIG. 2. At the bent portion, the inner tube 41, the outer tube 42, and the turbulator 45 are curved at substantially the same curvature.

Effects of the present disclosure will be described hereinafter.

(1) In the double-tube internal heat exchanger 4, the low-pressure refrigerant flowing through the inner flow channel 43 and the high-pressure refrigerant flowing through the outer flow channel 44 exchange heat with each other. As a result, the low-pressure refrigerant is heated, and the high-pressure refrigerant is cooled. Specifically, the low-pressure refrigerant in the gas state flowing from the evaporator 21 is heated while passing through the inner flow channel 43 and becomes a superheated gas refrigerant. Accordingly, it can be suppressed that a liquid-phase refrigerant flows into the compressor 31. In other words, the compressor 31 can be prevented from compressing a liquid-phase refrigerant. Therefore, an increase of a load applied on the compressor 31 can be suppressed. In addition, the high-pressure liquid refrigerant flowing from the condenser 32 is subcooled while passing through the outer flow channel 44. Accordingly, it can be suppressed that the high-pressure liquid refrigerant becomes a gas-phase refrigerant before flowing into the evaporator 21. In other words, the evaporator 21 can be prevented from evaporating a gas-phase refrigerant. Thus, a coefficient of performance (COP) of the refrigeration cycle device 3 can be improved.

Furthermore, since the inner tube 41 is covered by the outer tube 42, heat, which is generated in the engine 5 and radiated from the engine 5, has less effect on the low-pressure refrigerant flowing through the inner flow channel 43. As a result, a deterioration of air-conditioning, e.g., a cooling performance, can be suppressed.

(2) In the present embodiment, the inner tube 41 has the threaded portion. The threaded portion increases contact surfaces where the inner tube 41 is in contact with the low-pressure refrigerant (or the first fluid) flowing through the inner flow channel 43 and the high-pressure refrigerant (or the second fluid) flowing through the outer flow channel 44. Therefore, the convective heat exchange between the low-pressure refrigerant and the high-pressure refrigerant can be improved for a given length of the threaded portion of the inner tube 41.

In addition, the threaded portion of the inner tube 41 raises pressure losses both in the low-pressure refrigerant flowing through the inner flow channel 43 and in the high-pressure refrigerant flowing through the outer flow channel 44. As a result, the heat exchanging performance across the double-tube internal heat exchanger 4 can be improved.

(3) In the present embodiment, the turbulator 45 is inserted into the inner tube 41. The turbulator 45 causes a turbulent flow in the inner flow channel 43, while increasing the pressure loss of the low-pressure refrigerant flowing through in the inner flow channel 43. In this way, the low-pressure refrigerant is agitated and mixed evenly, whereby insufficient heat exchange caused by laminar flow of the low-pressure refrigerant passing around the axial center of the inner flow channel 43 can be suppressed. Therefore, the heat exchanging performance across the double-tube internal heat exchanger 4 can be further improved.

In addition, since the turbulator 45 causes the turbulent flow, a separation of the low-pressure refrigerant from the inner surface of the inner tube 41 can be suppressed. That is, the low-pressure refrigerant flows through the inner flow channel 43 while being in contact with the inner surface of the inner tube 41 certainly. Therefore, heat of the low-pressure refrigerant can transfer to the high-pressure refrigerant through the inner tube 41 certainly whereby the convective heat transfer can be improved.

Moreover, since the turbulator 45 is in contact with the inner tube 41, the heat of the low-pressure refrigerant transfers to the inner tube 41 through the turbulator 45. That is, the turbulator 45 promotes a heat transfer from the low-pressure refrigerant to the inner tube 41, and therefore, the inner tube 41 can transfer larger amount of heat to the high-pressure refrigerant flowing in the outer flow channel 44. As a result, the convective heat exchange can be further improved.

(4) In the present embodiment, the inner groove 41a is in contact with the outer tube 42 in the bent portion 46 and the outer groove 41b is not in contact with the outer tube 42. Accordingly, the outer tube 42 and the outer groove 41b can therebetween define the outer flow channel 44 certainly.

(5) In the present embodiment, the inner groove 41a and the outer groove 41b extend helically along the axial direction of the inner tube 41. Accordingly, when bending the double-tube portion, the inner tube 41 can be bent with a smaller distortion. As a result, the bent portion 46 can be formed easily with a small force. In addition, since the turbulator 45 is formed of the flexible core portion 45a and the loops 45b made of wires, an entirety of the turbulator 45 is flexible. That is, the turbulator 45 does not disturb bending the double-tube portion.

### Other Embodiments

While the present disclosure has been described with reference to a preferred embodiment thereof, it is to be understood that the disclosure is not limited to the preferred embodiment and configurations. The present disclosure is intended to cover various modification and equivalent arrangements, for example, as the following modifications.

In the above-described embodiment, each of the peaks of the inner groove 41a has at least one loop 45b. However, the peaks may include a peak having no loop 45b therein. In addition, the loops 45b may include a loop 45b not being in contact with the inner surface of the inner tube 41. Even when the loops 45b include a loop 45b not in contact with the inner surface of the inner tube 41, the rest of the loops 45b are in contact with the inner surface of the inner tube 41 and can transfer the heat of the low-pressure refrigerant to the inner tube 41.

In the above-described embodiment, the inner tube 41 is threaded in advance to form the threaded portion, and then the turbulator 45 is inserted into the threaded inner tube 41. However, the inner tube 41 may be threaded after the turbulator 45 is inserted into the inner tube 41. Since the entirety of the turbulator 45 is flexible as described above, the turbulator 45 is hardly damaged when force is applied thereto through the inner tube 41. Therefore, the double-tube internal heat exchanger 4 including the threaded inner tube 41 and the turbulator 45 positioned in the inner tube 41 can be manufactured easily.

In the above-described embodiment, the threaded portion of the inner tube 41 is formed by turning the inner tube 41 against a rotating die without twisting the inner tube 41. However, a method to form the threaded portion is not limited as long as the inner tube 41 is configured to raise the pressure loss in the low-pressure refrigerant and the high-pressure refrigerant. For example, the threaded portion of the inner tube 41 may be formed by twisting the inner tube 41. When forming the inner tube 41 by twisting, the turbulator 45 can be inserted into the inner tube 41 before or after twisting the inner tube 41. Even when the inner tube 41 is twisted after the turbulator 45 is inserted into the inner tube 41, the turbulator 45 is hardly damaged since the turbulator 45 is flexible as described above.

1. A double-tube internal heat exchanger comprising:
an outer tube;
an inner tube that is inserted into the outer tube and defines an inner flow channel therein through which a first fluid flows, the inner tube and the outer tube defining an outer flow channel therebetween through which a second fluid flows; and
a turbulator that is disposed inside the inner flow channel of the inner tube, wherein
the inner tube includes an inner surface defining an inner groove helically extending thereon along an axial direction of the inner tube,
the turbulator includes a flexible core portion extending along the axial direction and a plurality of loops protruding from the flexible core portion in a radial direction of the inner tube, and
each of the inner tube and the outer tube includes a bent portion that is formed by bending both the inner tube and the outer tube together with the turbulator.

2. The double-tube internal heat exchanger according to claim 1, wherein
the inner tube includes an outer surface defining an outer groove helically extending thereon along the axial direction of the inner tube, and
the inner groove and the outer groove are offset from each other along the axial direction of the inner tube

3. The double-tube internal heat exchanger according to claim 1, wherein
the plurality of loops are in contact with a bottom portion of the inner groove.

4. The double-tube internal heat exchanger according to claim 1, wherein
the plurality of loops are arranged along the axial direction of the inner tube at equal intervals.

5. A method for manufacturing a double-tube internal heat exchanger including an inner tube and an outer tube located inside the inner tube, the method comprising:
inserting a turbulator, which is formed of a flexible core portion and a plurality of loops, into the inner tube, the inner tube including an inner surface that defines an inner groove helically extending thereon along an axial direction of the inner tube; and
bending both the inner tube and the outer tube together with the turbulator.
